(19) United States
(12) Patent Application Publication
(10) Pub. No.: US 2010/0330447 A1
(43) Pub. Date: Dec. 30, 2010

(54) Fuel cell system and method

(75) Inventor: Yixin Zeng, Kariya-shi (JP)

Correspondence Address: OLIFF & BERRIDGE, PLC, P.O. BOX 320850, ALEXANDRIA, VA, 22320-4850, US

(73) Assignees: Toyota Jidosha Kabushiki Kaisha, Toyota-shi (JP); Aisin Seiki Kabushiki Kaisha, Kariya-shi (JP)

(21) Appl. No.: 12/923,033

(22) Filed: Aug. 30, 2010

Related U.S. Application Data
(62) Division of application No. 11/664,800, filed on Apr. 6, 2007.

(30) Foreign Application Priority Data
Oct. 29, 2004 (JP) 2004-317377

(51) Int. Cl. H01M 8/04

(52) U.S. Cl. 429/429

(57) ABSTRACT

A fuel cell system capable of appropriately regenerating a catalyst on a cathode side or an anode side is provided. A fuel cell system (1) includes regeneration processing means (21, 24, 33, 35) for performing a regeneration process that revives the catalyst in a fuel cell (2) from a state of lowered activity by controlling supply flow rates of fuel gas and oxidant gas supplied to the fuel cell (2), wherein the regeneration process for the catalyst on the cathode (12) side in the fuel cell (2) is performed by the regeneration processing means that decreases the flow rate of the oxidant gas to less than a steady-state requested rate in the relationship with the fuel gas to lower the cell voltage of the fuel cell (2) to a predetermined voltage. The regeneration process for the catalyst on the anode (13) side is similarly performed by the regeneration processing means that decreases the flow rate of the fuel gas to less than a steady-state requested rate in the relationship with the oxidant gas.

This is a Division of application Ser. No. 11/664,800 filed Apr. 6, 2007, which is a National Phase of Application No. PCT/JP2005/018721 filed Oct. 4, 2005, which claims priority to Japanese Patent Application No. 2004-317377 filed Oct. 29, 2004. The disclosure of the prior applications are hereby incorporated by reference herein in their entirety.

### BACKGROUND

The present invention relates to a fuel cell system regenerating a catalyst on a cathode side or an anode side in a fuel cell and a method for the same.

In a polymer electrolyte type fuel cell, the output voltage decreases over time under a constant output current. One of the major reasons is that, during the long-term operation of the fuel cell, impurities (for example, S component-containing substance, CO and the like) are deposited on the catalyst (for example, Pt) on the cathode side or the anode side in the fuel cell, which would lower the activity of the catalyst.

To solve this problem, there is known a fuel cell system in which a load device is arranged in parallel with a fuel cell (see, for example, Japanese Patent Laid-Open No. 2003-115318 (page 3 and FIG. 1)). In this system, oxidant gas and fuel gas are both supplied to the fuel cell in excessive amounts, to cause a current greater than in a rated operation to flow, to thereby revive the catalyst on the cathode side.

With such a conventional fuel cell system, however, an excess current exceeding the rated current value is generated, which might adversely affect the durability of the materials in the fuel cell and the components in the system.

### SUMMARY

An object of the present invention is to provide a fuel cell system capable of appropriately reviving a catalyst on a cathode side or an anode side and a method for the same.

To achieve the above object, according to the present invention, there is provided a fuel cell system that includes regeneration processing means for performing a regeneration process that revives a catalyst in a fuel cell from a state of lowered activity by controlling supply flow rates of fuel gas and oxidant gas supplied to the fuel cell. The regeneration process for the catalyst on a cathode side in the fuel cell is performed by the regeneration processing means that decreases the flow rate of the oxidant gas to less than a steady-state requested rate in the relationship with the fuel gas to lower the cell voltage of the fuel cell to a predetermined voltage.

According to this configuration, the flow rate of the oxidant gas is decreased to less than a steady-state requested rate in the relationship with the fuel gas, so that the potential of the cathode decreases, and the cell voltage is lowered to a predetermined voltage. As a result, reaction causing impurities deposited on the catalyst to be removed therefrom takes place on the cathode side, whereby the catalyst is revived to its active state. As described above, the regeneration process for the catalyst on the cathode side is carried out by decreasing the flow rate of the oxidant gas to less than the steady-state requested rate, which can appropriately suppress adverse effects on the durability of the fuel cell materials and the like.

Here, typical examples of the oxidant gas include oxide gas and air. Typical examples of the fuel gas include pure hydrogen, hydrogen reformed from natural gas or the like, and methanol.

Here, while the theoretical value of the cell voltage is 1.23 V, the cell voltage during a rated operation of the actual system is in the order of 0.8 V to 1.0 V. The “predetermined voltage” may be a low voltage suitable for regeneration of activity of the catalyst on the cathode side, which may be, e.g., in the order of 0.8 V to 0.2 V, or in the order of 0.8 V to 0.3 V.

The regeneration process for the catalyst on the cathode side may be carried out at the time of actuation, during a rated operation, and at the time of stoppage of the fuel cell, specifically in the following manner.

The regeneration process on the cathode side is preferably performed by the regeneration processing means that starts supply of the oxidant gas to the fuel cell after a delay from the start of supply of the fuel gas to the fuel cell at the time of actuation of the fuel cell. In this case, it is preferable that the regeneration processing means starts the supply of the oxidant gas to the fuel cell when the cell voltage becomes 0.3 V or less.

Similarly, the regeneration process on the cathode side is preferably performed by the regeneration processing means that decreases the flow rate of the oxidant gas for a predetermined period of time during a rated operation of the fuel cell.

Similarly, the regeneration process on the cathode side is preferably performed by the regeneration processing means that stops supply of the oxidant gas to the fuel cell before stopping supply of the fuel gas to the fuel cell at the time of stoppage of the fuel cell.

At the time of the regeneration process described above, power output from the fuel cell is preferably supplied to an external load connected to the fuel cell.

According to an embodiment of the present invention, the regeneration processing means includes: first flow rate control means for controlling the supply flow rate of the fuel gas supplied to the fuel cell; and second flow rate control means for controlling the supply flow rate of the oxidant gas supplied to the fuel cell. The first and second flow rate control means preferably control implementation of the regeneration process.

In this case, the first flow rate control means preferably includes at least one valve provided on a line through which the fuel gas flows. The second flow rate control means preferably includes at least one valve provided on a line through which the oxidant gas flows or an oxidant gas supplying device.

In consideration of the history through which the present invention has been reached, the present invention may be viewed from a different standpoint as follows.

Namely, according to the present invention, there is provided a fuel cell system performing a regeneration process that revives a catalyst in a fuel cell from a state of lowered activity by controlling supply flow rates of fuel gas and oxidant gas supplied to the fuel cell, which includes a first flow rate controller controlling the supply flow rate of the fuel gas supplied to the fuel cell, and a second flow rate controller controlling the supply flow rate of the oxidant gas supplied to the fuel cell. The regeneration process for the catalyst on a cathode side in the fuel cell is carried out by the first and second flow rate controller that control to decrease the flow rate of the oxidant gas to less than a steady-state requested rate in the relationship with the fuel gas to lower the cell voltage of the fuel cell to a predetermined voltage.

In this case, at the time of the regeneration process, power output from the fuel cell is preferably supplied to an external load connected to the fuel cell.

The regeneration process for the catalyst on the cathode side can be carried out at the time of actuation, during a rated operation, and at the time of stoppage of the fuel cell, specifically in the following manner.

The regeneration process for the catalyst on the cathode side is preferably performed by the first and second flow rate controller that control to start supply of the oxidant gas to the fuel cell after a delay from the start of supply of the fuel gas to the fuel cell at the time of actuation of the fuel cell.

Similarly, the regeneration process for the catalyst on the cathode side is preferably performed by the first and second flow rate controller that control to decrease the flow rate of the oxidant gas for a predetermined period of time during a rated operation of the fuel cell.

Similarly, the regeneration process for the catalyst on the cathode side is preferably performed by the first and second flow rate controller that control to stop supply of the oxidant gas to the fuel cell before stopping supply of the fuel gas to the fuel cell at the time of stoppage of the fuel cell.

The first flow rate controller preferably includes at least one valve provided on a line through which the fuel gas flows.

The second flow rate controller preferably includes at least one valve provided on a line through which the oxidant gas flows or an oxidant gas supplying device.

According to the present invention, there is provided another fuel cell system that includes regeneration processing means for performing a regeneration process that revives a catalyst in a fuel cell from a state of lowered activity by controlling supply flow rates of fuel gas and oxidant gas supplied to the fuel cell. The regeneration process for the catalyst on an anode side in the fuel cell is performed by the regeneration processing means that decreases the flow rate of the fuel gas to less than a steady-state requested rate in the relationship with the oxidant gas to lower the cell voltage of the fuel cell to a predetermined voltage.

With this configuration, similarly to the case of the regeneration process on the cathode side described above, the flow rate of the fuel gas is decreased to less than a steady-state requested rate in the relationship with the oxidant gas, so that the potential of the anode increases, and the cell voltage is lowered to a predetermined voltage. As a result, reaction causing the impurities deposited on the catalyst to be removed therefrom takes place on the anode side, whereby the catalyst is revived to its active state. As described above, the regeneration process for the catalyst on the anode side is carried out by decreasing the flow rate of the fuel gas to less than a steady-state requested rate, and accordingly, it is possible to appropriately suppress adverse effects on the durability of the fuel cell materials and the like.

The regeneration process for the catalyst on the anode side, similarly to the regeneration process on the cathode side, can be carried out at the time of actuation, during a rated operation, and at the time of stoppage of the fuel cell, specifically in the following manner.

The regeneration process on the anode side is preferably performed by the regeneration processing means that starts supply of the fuel gas to the fuel cell after a delay from the start of supply of the oxidant gas to the fuel cell at the time of actuation of the fuel cell.

Similarly, the regeneration process on the anode side is preferably performed by the regeneration processing means that decreases the flow rate of the fuel gas for a predetermined period of time during a rated operation of the fuel cell.

Similarly, the regeneration process on the anode side is preferably performed by the regeneration processing means that stops supply of the fuel gas to the fuel cell before stopping supply of the oxidant gas to the fuel cell at the time of stoppage of the fuel cell.

At the time of the regeneration process, power output from the fuel cell is preferably supplied to an external load connected to the fuel cell. Further, the regeneration processing means may include first and second flow rate control means, similarly as described above, and the first and second flow rate control means may control to implement the regeneration process.

In consideration of the history through which the present invention has been reached, the present invention may be viewed from a different standpoint as follows.

Namely, according to the present invention, there is provided a fuel cell system performing a regeneration process that revives a catalyst in a fuel cell from a state of lowered activity by controlling supply flow rates of fuel gas and oxidant gas supplied to the fuel cell, which includes a first flow rate controller controlling the supply flow rate of the fuel gas supplied to the fuel cell, and a second flow rate controller controlling the supply flow rate of the oxidant gas supplied to the fuel cell. The regeneration process for the catalyst on an anode side in the fuel cell is carried out by the first and second flow rate controller that control to decrease the flow rate of the fuel gas to less than a steady-state requested rate in the relationship with the oxidant gas to lower the cell voltage of the fuel cell to a predetermined voltage.

In this case, at the time of the regeneration process, power output from the fuel cell is preferably supplied to an external load connected to the fuel cell.

The regeneration process on the anode side is preferably performed by the first and second flow rate controller that control to start supply of the fuel gas to the fuel cell after a delay from start of supply of the oxidant gas to the fuel cell at the time of actuation of the fuel cell.

Similarly, the regeneration process on the anode side is preferably performed by the first and second flow rate controller that control to decrease the flow rate of the fuel gas for a predetermined period of time during a rated operation of the fuel cell.

Similarly, the regeneration process on the anode side is preferably performed by the first and second flow rate controller that control to stop supply of the fuel gas to the fuel cell before stopping supply of the oxidant gas to the fuel cell at the time of stoppage of the fuel cell.

The first flow rate controller preferably includes at least one valve provided on a line through which the fuel gas flows.

The second flow rate controller preferably includes at least one valve provided on a line through which the oxidant gas flows or an oxidant gas supplying device.

According to the present invention, there is provided another fuel cell system that includes: first flow rate control means (controller) for controlling a flow rate of fuel gas supplied to a fuel cell; and second flow rate control means (controller) for controlling a flow rate of oxidant gas supplied to the fuel cell; wherein at the time of stoppage of the fuel cell, the second flow rate control means (controller) stops supply of the oxidant gas after the first flow rate control means (controller) stops supply of the fuel gas, and at the time of actuation of the fuel cell, the second flow rate control means (controller) starts the supply of the oxidant gas after the first flow rate control means (controller) starts the supply of the fuel gas.

With this configuration, at the time of stoppage of the fuel cell, the flow rate of the fuel gas can be decreased to less than a steady-state requested rate in the relationship with the oxidant gas, which makes it possible to implement the regeneration process for the catalyst on the anode side. At the time of actuation of the fuel cell, the flow rate of the oxidant gas can be decreased to less than a steady-state requested rate in the relationship with the fuel gas, which makes it possible to implement the regeneration process for the catalyst on the cathode side. Accordingly, it is possible to appropriately complete the regeneration processes for the catalysts on both of the cathode side and the anode side before the next rated operation of the fuel cell, without adversely affecting the durability of the fuel cell materials and the like.

According to the present invention, there is also provided a method for reviving a catalyst in a fuel cell from a state of lowered activity by controlling supply flow rates of fuel gas and oxidant gas supplied to the fuel cell, which includes the step of regenerating the catalyst on a cathode side in the fuel cell by decreasing the flow rate of the oxidant gas to less than a steady-state requested rate in the relationship with the fuel gas to lower the cell voltage of the fuel cell to a predetermined voltage.

According to the present invention, there is provided another method for reviving a catalyst in a fuel cell from a state of lowered activity by controlling supply flow rates of fuel gas and oxidant gas supplied to the fuel cell, which includes the step of regenerating the catalyst on an anode side in the fuel cell by decreasing the flow rate of the fuel gas to less than a steady-state requested rate in the relationship with the oxidant gas to lower the cell voltage of the fuel cell to a predetermined voltage.

In these cases, the regenerating step described above is preferably performed at least at one of the time of actuation, the time of rated operation, and the time of stoppage of the fuel cell.

According to the present invention, there is provided yet another method for reviving a catalyst in a fuel cell from a state of lowered activity by controlling supply flow rates of fuel gas and oxidant gas supplied to the fuel cell. The method includes the steps of: stopping supply of the oxidant gas after stopping supply of the fuel gas at the time of stoppage of the fuel cell; and starting the supply of the oxidant gas after starting the supply of the fuel gas at the time of actuation of the fuel cell following the stopping step.

According to the fuel cell systems of the present invention described above, it is possible to appropriately revive the catalyst on the cathode side or the anode side, and to appropriately maintain the output performance of the fuel cell.

### DESCRIPTION OF THE DRAWINGS

FIG. 1 is a diagram showing a configuration of the main part in a fuel cell system.

### DETAILED DESCRIPTION

Hereinafter, a preferred embodiment of the present invention will be described with reference to the accompanying drawing.

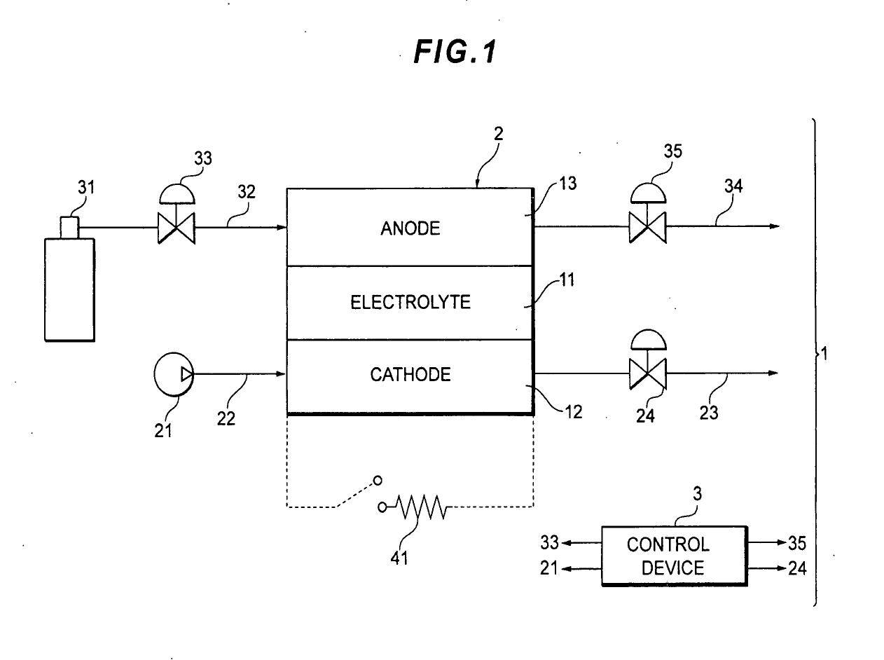

As shown in FIG. 1, a fuel cell system 1 mounted for example on a fuel cell vehicle includes a polymer electrolyte type fuel cell 2, which is suitable to be mounted on a vehicle, and a control device 3 performing overall control of the entire system. The fuel cell 2 has a stacked structure with a large number of single cells stacked one on another, which receives supply of oxygen (air) as oxidant gas and hydrogen as fuel gas and generates power. In the case of using the fuel cell 2 for a stationary application, a polymer electrolyte type fuel cell or a phosphoric acid type fuel cell is suitable. A stationary fuel cell system has a similar fuel cell 2 and a similar control device 3.

The single cell of the fuel cell 2 has a cathode 12 (air electrode) and an anode 13 (fuel electrode) arranged on the respective sides of an electrolyte membrane 11 made of an ion-exchange membrane. The cathode 12 is configured with a diffusion layer of a porous carbon material for example, to which platinum is bound as a catalyst. Similarly, the anode 13 is configured with a diffusion layer of a porous carbon material for example, to which platinum is bound as a catalyst.

Hydrogen is supplied to the anode 13, and reaction as indicated by the expression (1) is promoted by the platinum catalyst at the anode 13. Oxygen is supplied to the cathode 12, and reaction as indicated by the expression (2) is promoted by the platinum catalyst at the cathode 12. For the single cell of the fuel cell 2 as a whole, electromotive reaction as indicated by the expression (3) takes place.

H₂→2H⁺+2e⁻ (1)

(½)O₂+2H⁺+2e⁻→H₂O (2)

H₂+(½)O₂→H₂O (3)

The oxidant gas is supplied by a compressor 21 to the cathode 12 in the fuel cell 2 via a supply line 22. The oxidant gas discharged from the fuel cell 2 (unreacted oxidant gas) is discharged via a discharge line 23 to the outside. A valve 24 provided on the discharge line 23 is configured to be capable of adjusting the flow rate of the oxidant gas supplied to the cathode 12. It is noted that a blower may be used as an oxidant gas supplying device, instead of the compressor 21, to pump the oxidant gas to the fuel cell 2.

The fuel gas is stored in a gas supply source 31 such as a high-pressure tank, and is supplied to the anode 13 in the fuel cell 2 via a supply line 32. The gas supply source 31 may store pure hydrogen gas, or may store natural gas or gasoline in the case of reforming the same to the hydrogen gas in a vehicle or a stationary system, for example. In the latter case, a reformer is provided on the supply line 32, and the hydrogen gas reformed by the reformer (reformed gas) is supplied to the anode 13.

The supply line 32 has a valve 33 capable of adjusting the flow rate of the fuel gas to be supplied to the anode 13. Further, a discharge line 34 discharging the fuel gas (unreacted fuel gas) from the fuel cell 2 to the outside has a valve 35 capable of adjusting the flow rate of the fuel gas supplied to the anode 13. It is noted that the discharge line 34 may be configured to merge with the supply line 32, to allow circulating supply of the fuel gas to the fuel cell 2 by a pump and the like.

The valves 24, 33 and 35 are configured to be capable of adjusting the valve opening degrees in the passages of the corresponding lines 23, 32 and 34. For example, the valves 24, 33 and 35 may each be configured with a pressure regulating valve or a flow rate control valve capable of appropriately setting the valve opening degree in accordance with the output of the fuel cell 2. Further, the valves 24, 33 and 35 may each be configured with a shut-off valve shutting the passage of the corresponding line. The valves 24, 33 and 35 are connected to the control device 3 and function as flow rate control means (flow rate controllers) together with the compressor 21.

Specifically, the valves 33 and 35 work independently or cooperatively to constitute first flow rate control means that controls the flow rate of the fuel gas supplied to the anode 13. That is, at least one of the valves 33 and 35 corresponds to a first flow rate controller. Similarly, the compressor 21 and the valve 24 work independently or cooperatively, to constitute second flow rate control means that controls the flow rate of the oxidant gas supplied to the cathode 12. That is, at least one of the compressor 21 and the valve 24 corresponds to a second flow rate controller. As these two flow rate control means (flow rate controllers) work, the supply flow rates of the reaction gases (fuel gas and oxidant gas) supplied to the fuel cell 2 are controlled, and thus, actuation, stoppage and rated operation of the fuel cell 2 are controlled appropriately. As will be described later, these two flow rate control means (flow rate controllers) are controlled cooperatively, to serve as regeneration processing means that performs a regeneration process that revives the catalyst of the fuel cell 2 from a state of lowered activity by controlling the supply flow rates of the reaction gases supplied to the fuel cell 2.

During the long-term operation of the fuel cell 2, the activity of the catalyst (platinum) on the cathode 12 side in the fuel cell 2 lowers, mainly for the following reason. In the cathode 12, besides the reaction as indicated by the expression (2) above, oxidation reaction of water as indicated by the expression (4):

Pt+H₂O→PtOH+H⁺+e⁻ Expression (4)

and oxidation reaction of impurities in the air concurrently occur on the catalyst. As a result of such secondary reactions, reaction products such as PtOH and the like are generated, and impurities deposited on the catalyst would lower the activity of the catalyst for the oxidation-reduction reaction. This is not restricted to the catalyst on the cathode 12 side, but the catalyst (platinum) on the anode 13 side similarly suffers lowering of the activity. Such lowered activity of the catalysts would result in lowered output performance of the fuel cell 2 over time.

Here, the impurities deposited on the catalyst on the cathode 12 side may include sulfur (S), nitrogen oxide (NOx) and the like, and also include chlorine (Cl) in the case where the vehicle runs near the sea, for example. The impurities deposited on the catalyst on the anode 13 side may include methane (CH₄), carbon monoxide (CO), carbon dioxide (CO₂), sulfur oxide (SOx) and the like, especially in the case of the fuel cell system 1 using a reformer.

In the fuel cell system 1 of the present embodiment, the regeneration processing means having two flow rate control means (mainly composed of compressor 21, valve 24, valve 33, and valve 35) is configured to perform the catalyst regeneration process to activate the catalyst. The catalyst regeneration process is carried out by connecting an external load 41 (dummy resistive element) to the fuel cell 2. The external load 41 may be a secondary battery, a storage device such as a capacitor, a heater, or an appliance using power such as a home electric appliance. Alternatively, the external load 41 may be a simple resistive element. When the switch of the external load 41 is turned ON, it receives supply of power output from the fuel cell 2 and consumes the same. When the switch of the external load 41 is turned OFF, the supply of the power output from the fuel cell 2 is shut off.

Hereinafter, the regeneration process for the catalyst on the cathode 12 side, the regeneration process for the catalyst on the anode 13 side, and the regeneration process performing both of them concurrently, will be explained in turn.

### [1. Regeneration Process for Cathode]

The regeneration process for the Pt catalyst on the cathode 12 side is for reviving the oxygen reaction activity at the cathode 12 by reducing PtOH and others generated according to the above expression (4) and the like to Pt. This regeneration process is carried out, in the state where the fuel cell 2 is connected to the external load 41 (in the state where the switch is ON), by the regeneration processing means (21, 24, 33, 35) that decreases the flow rate of the oxidant gas to less than a steady-state requested rate in the relationship with the fuel gas (hydrogen). As the flow rate of the oxidant gas decreases, the potential of the cathode 12 decreases, and the cell voltage is lowered to a predetermined voltage. Accordingly, the catalyst on the cathode 12 side is revived to an active catalyst, with the impurities deposited thereon being removed.

Specifically, when the flow rate of the oxidant gas is decreased, the reaction of the above expression (2) is restricted. Instead, for example the reaction as indicated by the expression (5):

PtOH+H⁺+e⁻→Pt+H₂O Expression (5)

is promoted on the catalyst, so that OH⁻ is removed from Pt. Similar reactions are promoted for the other impurities, and accordingly, the catalyst is revived to its active state.

Hereinafter, the cases of performing such regeneration process at the time of actuation, during a rated operation, and at the time of stoppage of the fuel cell 2 will be explained in turn.

### [1-1. At the Time of Actuation]

When actuating the fuel cell 2, i.e., when starting up the fuel cell system 1 to extract a current from the fuel cell 2, the fuel gas is supplied to the fuel cell 2 before the oxidant gas is supplied to the fuel cell 2, in the state where the fuel cell 2 is connected to the external load 41. Specifically, the control device 3 opens the valves 33 and 35 provided on the passage of the fuel gas, to start the supply of the fuel gas to the fuel cell 2.

After a lapse of a predetermined period of time, when the cell voltage becomes 0.3 V or less, driving of the compressor 21 is started to thereby start the supply of the oxidant gas to the fuel cell 2. Although the valve 24 on the discharge line 23 may be closed at this time, it is preferable to cooperatively control the valve 24 with the compressor 21 to supply the oxidant gas of a predetermined flow rate to the fuel cell 2. The predetermined flow rate is controlled such that the cell voltage falls within a low voltage range suitable for regeneration of the activity of the catalyst on the cathode 12 side. The low voltage range herein is preferably in the order of 0.8 V to 0.2 V or in the order of 0.8 V to 0.3 V.

### [1-2. During Rated Operation]

During the rated operation of the fuel cell 2, i.e., while the fuel cell 2 is generating power based on an output request, the flow rate of the oxidant gas supplied to the fuel cell 2 is decreased for a predetermined period of time in the state where the fuel cell 2 is connected to the external load 41. Specifically, the valve 24 provided on the discharge line 23 is closed or the flow rate is decreased to the level near that state, to adjust the flow rate of the oxidant gas such that the stoichiometric reaction ratio becomes 1 or less. Further, the driving of the compressor 21 is stopped cooperatively with or independently of the valve 24, or the driving of the compressor 21 is controlled to reduce the discharged amount of air.

The regeneration process for the cathode 12 during the rated operation of the fuel cell 2 may be carried out by decreasing the flow rate of the oxidant gas once for every one hour, for example. After maintaining the cell voltage within the above-described range (for example, from 0.8 V to 0.2 V) or within the range of 0.7 V to 0.01 V for 30 seconds for example, the oxidant gas may be supplied to the fuel cell 2 at the flow rate corresponding to the steady-state requested rate.

### [1-3. At the Time of Stoppage]

When stopping the fuel cell 2, i.e., when stopping the operation of the fuel cell system 1, the supply of the oxidant gas to the fuel cell 2 is stopped before the supply of the fuel gas to the fuel cell 2 is stopped. Specifically, the driving of the compressor 21 is stopped to thereby stop the supply of the oxidant gas to the fuel cell 2. Although the valve 24 may be opened at this time, it is preferable to close the same. After a lapse of a predetermined period of time, when the cell voltage attains the above-described predetermined voltage (for example, 0.8 V to 0.2 V), the valves 33 and 35 are closed to thereby stop the supply of the fuel gas to the fuel cell 2.

### [2. Regeneration Process for Anode]

The regeneration process for the Pt catalyst on the anode 13 side is carried out similarly in the state where the fuel cell 2 is connected to the external load 41. This regeneration process is carried out by the regeneration processing means (21, 24, 33, 35) that decreases the flow rate of the fuel gas to less than a steady-state requested rate in the relationship with the oxidant gas, to increase the potential of the anode 13 to thereby lower the cell voltage to a predetermined voltage. This removes the impurities deposited on the catalyst on the anode 13 side, and thus, the catalyst is revived to its active state. Hereinafter, the cases of performing this regeneration process at the time of actuation, during a rated operation, and at the time of stoppage of the fuel cell 2 will be explained briefly in turn.

### [2-1. At the Time of Actuation]

When actuating the fuel cell 2, the oxidant gas is supplied to the fuel cell 2 before the fuel gas is supplied to the fuel cell 2, in the state where the fuel cell 2 is connected to the external load 41. Specifically, in the state where the valves 33 and 35 are closed so as not to supply the fuel gas to the fuel cell 2, driving of the compressor 21 is started to thereby start the supply of the oxidant gas to the fuel cell 2. Alternatively, the valve 24 provided on the discharge line 23 may be opened in the state where the valves 33 and 35 are closed, such that the outside air is naturally supplied to the fuel cell 2 from an exhaust port of the discharge line 23.

In the case where a reformer is provided on the supply line 32 from the gas supply source 31, it may be possible to stop supply of reformed fuel such as natural gas or the like, besides the method of closing the valves 33 and 35, or it may also be possible to cause a gas reformed to hydrogen to bypass the fuel cell 2 by operating a switching valve or the like, which is not shown in the FIGURE.

After a lapse of a predetermined period of time from the start of the supply of the oxidant gas, the valves 33 and 35 are opened to start the supply of the fuel gas to the fuel cell 2. At this time, it is controlled such that the cell voltage falls within a low voltage range while maintaining a positive polarity suitable for regenerating the activity of the catalyst on the anode 13 side. The cell voltage is controlled so as not to become 0.01 V or less, and when it becomes 0.01 V or less, the external load 41 is disconnected from the fuel cell 2 (the switch is turned OFF) to stop discharge.

### [2-2. During Rated Operation]

During the rated operation of the fuel cell 2, the flow rate of the fuel gas supplied to the fuel cell 2 is decreased for a predetermined period of time, in the state where the fuel cell 2 is connected to the external load 41. Specifically, at least one of the valve 33 and the valve 35 is closed or the flow rate is decreased to the level near that state, to adjust the flow rate of the fuel gas. At this time, it is controlled such that the stoichiometric reaction ratio becomes 1 or less. In this case as well, the cell voltage is controlled not to become 0.01 V or less.

### [2-3. At the Time of Stoppage]

When stopping the fuel cell 2, the supply of the fuel gas is stopped before the supply of the oxidant gas is stopped, in the state where the fuel cell 2 is connected to the external load 41. Specifically, the valves 33 and 35 are firstly closed to stop the supply of the fuel gas to the fuel cell 2. In the case where a reformer is provided, the supply of the reformed fuel is stopped for example, similarly as described above. While the supply of the oxidant gas to the fuel cell 2 is continued, the driving of the compressor 21 may also be continued, or alternatively, the driving of the compressor 21 may be stopped such that the outside air is naturally supplied to the fuel cell 2 from the exhaust port of the discharge line 23.

As the cell voltage starts to decrease after a lapse of a predetermined period of time, it is controlled such that the cell voltage is in a low voltage range, maintaining the positive polarity suitable for regeneration of the activity of the catalyst on the anode 13 side. Similarly as described above, when the cell voltage becomes 0.01 V or less, the external load 41 is disconnected from the fuel cell 2 (the switch is turned OFF) to stop discharge. Thereafter, the driving of the compressor 21 is completely stopped and the valve 24 is also closed, to stop the supply of the oxidant gas to the fuel gas 2.

### [3. Regeneration Process for Cathode and Anode]

This regeneration process is a combination of the regeneration process for the cathode 12 and the regeneration process for the anode 13 described above. Specifically, the regeneration process for the anode 13 is carried out when the fuel cell 2 is stopped (see 2-3.), and the regeneration process for the cathode 12 is carried out when the fuel cell 2 is actuated next time (see 1-1.). These regeneration processes can be carried out similarly as described above, and thus, detailed description thereof will not be repeated here.

By performing these two regeneration processes in this order, the regeneration processes for the catalysts on the cathode 12 side and the anode 13 side can be completed appropriately before the next operation of the fuel cell 2. Further, almost all the residual hydrogen can be spent by the regeneration process for the anode 13 when stopping the fuel cell 2, which considerably restricts transmission of the hydrogen to the cathode 12 during the stopped period of the system. It is noted that the combination of the regeneration process for the cathode 12 (1-1, 1-2, 1-3) and the regeneration process for the anode 13 (2-1, 2-2, 2-3) can be set as appropriate, for example such that the regeneration process for the cathode 12 is carried out when stopping the fuel cell 2 and the regeneration process for the anode 13 is carried out at the next actuation of the fuel cell 2, and the like.

1. A method for regenerating a catalyst in a fuel cell system, the method comprising:
reviving a catalyst on a cathode side or an anode side in a fuel cell from a state of lowered activity by operating a regeneration processing means including first flow rate control means for controlling a supply flow rate of fuel gas supplied to the fuel cell, and second flow rate control means for controlling a supply flow rate of oxidant gas supplied to the fuel cell, wherein
operating the regeneration processing means including the first and second flow rate control means comprises:
decreasing either
(i) the supply flow rate of oxidant gas supplied to the fuel cell to less than a steady-state requested rate in the relationship with fuel gas supplied to the fuel cell to lower the cell voltage of the fuel cell to a predetermined voltage, or
(ii) the supply flow rate of fuel gas supplied to the fuel cell to less than a steady-state requested rate in the relationship with oxidant gas supplied to the fuel cell to lower the cell voltage of the fuel cell to a predetermined voltage, and
when actuating the fuel cell, the regeneration is performed by either one of the starting of the supply of the fuel gas by the first flow rate control means and the starting of the supply of the oxidant gas by the second flow rate control means is conducted, and then either one of the other of the starting of the supply of the fuel gas by the first flow rate control means and the starting of the supply of the oxidant gas by the second flow rate control means is conducted.

2. The method according to claim 1, wherein when the regeneration takes place, power output from the fuel cell is supplied to an external load connected to the fuel cell.

3. The method according to claim 1, wherein when actuating the fuel cell, the regeneration process is performed by the second flow rate control means starting the supply of the oxidant gas after the first flow rate control means starts the supply of the fuel gas.

4. The method according to claim 1, wherein the second flow rate control means starts the supply of the oxidant gas to the fuel cell when the cell voltage becomes 0.3 V or less.

5. The method according to claim 1, wherein the first flow rate control means includes at least one valve provided on a line through which the fuel gas flows.

6. The method according to claim 1, wherein the second flow rate control means includes at least one valve provided on a line through which the oxidant gas flows or an oxidant gas supplying device.

7. The method according to claim 1, wherein when actuating the fuel cell, the regeneration process is performed by the first flow rate control means starting the supply of the fuel gas after the second flow rate control means starts the supply of the oxidant gas.

8. A method for regenerating a catalyst in a fuel cell system, the method comprising:
reviving a catalyst on a cathode side or an anode side in a fuel cell from a state of lowered activity by operating a regeneration processing means including first flow rate control means for controlling a supply flow rate of fuel gas supplied to the fuel cell, and second flow rate control means for controlling a supply flow rate of oxidant gas supplied to the fuel cell, wherein operating the regeneration processing means including the first and second flow rate control means comprises:
decreasing either
(i) the supply flow rate of oxidant gas supplied to the fuel cell to less than a steady-state requested rate in the relationship with fuel gas supplied to the fuel cell to lower the cell voltage of the fuel cell to a predetermined voltage, or
(ii) the supply flow rate of fuel gas supplied to the fuel cell to less than a steady-state requested rate in the relationship with oxidant gas supplied to the fuel cell to lower the cell voltage of the fuel cell to a predetermined voltage, and
when stopping the fuel cell, the regeneration is performed by either one of the stopping of the supply of the fuel gas by the first flow rate control means and the stopping of the supply of the oxidant gas by the second flow rate control means is conducted, and then either one of the other of the stopping of the supply of the fuel gas by the first flow rate control means and the stopping of the supply of the fuel gas by the second flow rate control means is conducted.

9. The method according to claim 8, wherein when stopping the fuel cell, the regeneration process is performed by the first flow rate control means stopping the supply of the fuel gas after the second flow rate control means stops supply of the oxidant gas.

10. The method according to claim 8, wherein when the regeneration takes place, power output from the fuel cell is supplied to an external load connected to the fuel cell.

11. The method according to claim 8, wherein the first flow rate control means includes at least one valve provided on a line through which the fuel gas flows.

12. The method according to claim 8 wherein the second flow rate control means includes at least one valve provided on a line through which the oxidant gas flows or an oxidant gas supplying device.

13. The method according to claim 8, wherein when stopping the fuel cell, the regeneration process is performed by the second flow rate control means stopping the supply of the oxidant gas after the first flow rate control means stops the supply of the fuel gas.
